(19) United States
(12) Patent Application Publication
(10) Pub. No.: US 2002/0134001 A1
(43) Pub. Date: Sep. 26, 2002

(54) Scent dispenser

(76) Inventor: John R. Burgeson, Anoka, MN (US)

Correspondence Address: RIDER, BENNETT, EGAN & ARUNDEL, 333 SOUTH SEVENTH STREET, SUITE 2000, MINNEAPOLIS, MN, 55402, US

(21) Appl. No.: 09/815,030

(22) Filed: Mar. 22, 2001

(51) Int. Cl. A01M 1/00

(52) U.S. Cl. 43/1

(57) ABSTRACT

A scent dispenser for attracting game and dipping into a scent container has an absorbent member with an aperture for suspending the absorbent member from a rod, stick or pole. The absorbent member has legs with a gap between them that allows each leg to be dipped into a container holding scent to be dispensed. The scent dispenser can be used in a method of dispensing scent about the hunting position by suspending the scent dispenser from a rod, stick or pole and walking about the hunting position with the scent dispenser dripping scent onto the ground.

### BACKGROUND OF THE INVENTION

The present invention relates generally to devices used in hunting for the release of attractant scents, and more particularly, to a scent wick that can be dipped into a bottle and then used to dispense the scent as the hunter walks through the woods.

The use of animal attractant scents by hunters to increase their chances of hunting success is well known. In particular, these scents can be used in ways to take advantage of the mating processes of certain species. For example, in the case of white tail deer, it is known that the buck will prepare a “scrape” to attract a doe. The scrape is prepared by the buck as he scrapes the ground with his hooves at a particular spot and deposits some urine thereon. This action can serve to attract a doe who will then periodically deposit a particular scent, produced when in heat, on the scrape, thereby indicating her receptiveness for mating. The buck will, in this manner, be alerted to the presence of the doe and will tend to spend more time in the location of his scrape. This increase in time spent in a particular area makes him easier to hunt.

Thus, hunters will prepare an artificial scrape, or locate a natural scrape, in an attempt to attract a buck. This is done by scraping the ground in a manner similar to that of the buck, and then depositing a commercially available scent thereon as shown in co-owned U.S. Pat. No. 5,361,257 that signals to the buck the presence of a doe in the correct stage of her estrus cycle.

Some hunters do not wish to make artificial scrapes or tamper with real scrapes. Rather, the hunters will simply establish a protected position or stand to hunt from, around which they will distribute the scent. Various scent dispensing devices are known, such as those shown in U.S. Pat. Nos. 5,035,435; 4,523,717; 3,046192; and 2,959,354. Such earlier scent dispensers include absorbent material to hold and permit the slow release of the scent therefrom in the ambient air. However, many such earlier dispensers are complicated or simply do not protect the scent wick from harsh weather conditions, including wind, rain, and snow, which will significantly affect the effectiveness of the scent dispersion.

In addition, such dispensers have typically been hung at a particular location, with the scent dripping out of the dispenser. In order to distribute scent more broadly around the hunter's position, it would be necessary to use several of such dispensers.

There is therefore a need for a scent dispenser that allows scent to be dispensed while the hunter walks through the woods around his stand location.

### SUMMARY OF THE INVENTION

A scent dispenser for attracting game and dipping into a scent container has an absorbent member with an aperture for suspending the absorbent member from a rod, stick or pole. The absorbent member has legs with a gap between them that allows each leg to be dipped into a container holding scent to be dispensed. The scent dispenser can be used in a method of dispensing scent about the hunting position by suspending the scent dispenser from a rod, stick or pole and walking about the hunting position with the scent dispenser dripping scent onto the ground.

A principal object and advantage of the present invention is that it allows a hunter to distribute scent in various locations about his hunting position.

Another principal object and advantage of the present invention is that it can be suspended from a rod, stick or pole, allowing the hunter to walk on a trail with the scent dispenser suspended away from the trail.

Another principal object and advantage of the present invention is that the scent dispenser has legs with a gap between them that allows each leg to be inserted into the narrow mouth of a scent container.

### BRIEF DESCRIPTION OF THE DRAWINGS

FIG. 1 is a front elevational view of the scent dispenser of the present invention.

FIG. 2 is a side elevational view of the scent dispenser of the present invention.

FIG. 3 is a top plan view of the scent dispenser of the present invention.

FIG. 4 is a bottom plan view of the scent dispenser of the present invention.

FIG. 5 is a perspective view showing the scent dispenser of the present invention being inserted into a scent container.

FIG. 6 is a perspective view showing a hunter using the scent dispenser of the present invention to distribute scent about his hunting position.

### DETAILED DESCRIPTION OF THE PREFERRED EMBODIMENT

The scent dispenser of the present invention is generally shown in the Figures as reference numeral 10.

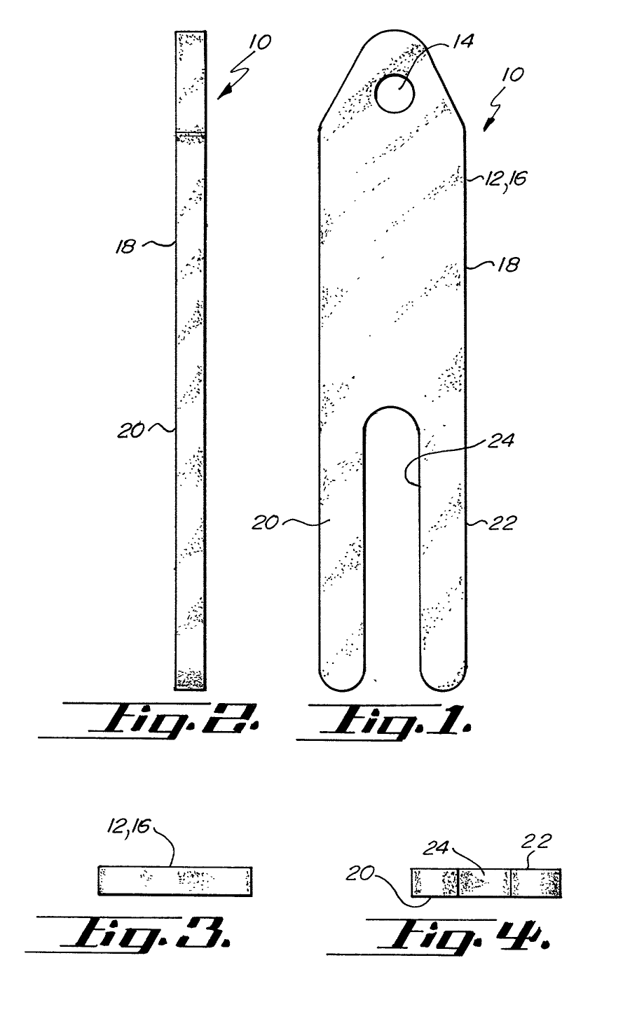

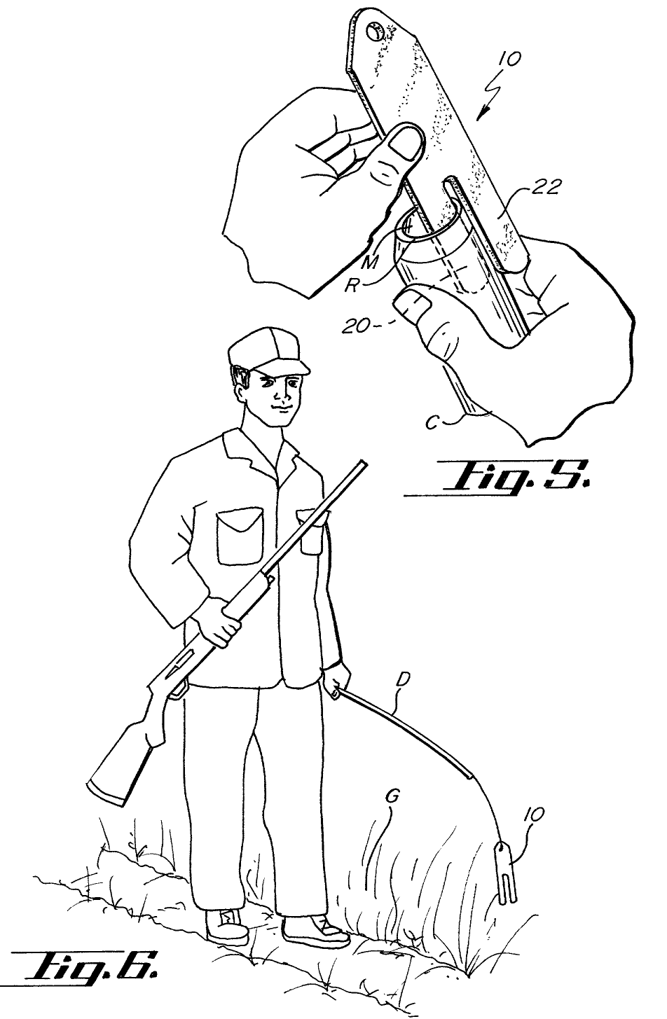

As best seen in FIG. 1, the scent dispenser 10 comprises an absorbent member 12 having an aperture 14 therethrough for suspending the absorbent member.

More particularly, the absorbent member 12 further comprises an elongate member 16 having a first portion 18 with the aperture 14 therethrough and a pair of legs 20, 22 attached to the first portion 18. The legs 20, 22 have a gap 24 therebetween.

As best seen in FIG. 5, the gap 24 allows the legs 20,22 to be inserted into a scent container C, with the rim R of the container C entering the gap. In this way, a container C may be used that has a mouth M that is narrower than the scent dispenser 10.

As best seen in FIGS. 5 and 6, in another aspect the present invention comprises a method of dispensing attractant scent about a hunting position, comprising the steps of: a) dipping the scent dispenser 10 into the scent container C, the scent dispenser 10 absorbing scent from the scent container; b) suspending the scent dispenser 10 from a rod, stick, or pole D; and c) walking about the hunting position with the scent dispenser 10 suspended from the rod, stick or pole, so that scent from the scent dispenser drips onto the ground G. More particularly, the gap 24 allows each leg 20, 22 to be inserted into the scent container with the rim R of the container C entering the gap 24.

The present invention may be embodied in other specific forms without departing from the spirit or essential attributes thereof, and it is therefore desired that the present embodiment be considered in all respects as illustrative and not restrictive.

What is claimed:

1. A scent dispenser for attracting game and for dipping into a scent container, comprising:
a) an absorbent member; and
b) an aperture through the absorbent member for suspending the absorbent member.

2. The scent dispenser of claim 1, wherein the absorpent member further comprises an elongate member having a first position with the aperture therethrough and a pair of legs attached to the first portion, the legs having a gap therebetween, each leg being adapted to be inserted into the scent container, with the rim of the scent container entering the gap.

3. A method of dispensing attactrant scent about a hunting position, comprising the steps of:
a) dipping a scent dispenser into a scent container, the scent dispenser absorbing scent from the scent container;
b) suspending the scent dispenser from a rod; and
c) walking about the hunting position with the scent dispenser suspended from the rod, whereby scent from the scent dispenser drips onto the ground.

4. The method of claim 3, wherein the scent dispenser has a pair of legs with a gap therebetween, and wherein each leg is inserted into the scent container with the rim of the container entering the gap.
